(19) United States
(12) Patent Application Publication
(10) Pub. No.: US 2002/0166355 A1
(43) Pub. Date: Nov. 14, 2002

(54) Lock device for bicycle

(76) Inventor: Chi-Yuan Li, Taipei (TW)

Correspondence Address: Chi-Yuan Li, P. O. Box 96-405, Taipei, 106, TW

(21) Appl. No.: 09/853,303

(22) Filed: May 9, 2001

(51) Int. Cl. E05B 71/00; E05B 29/04

(52) U.S. Cl. 70/233; 70/366; 70/491

(57) ABSTRACT

A lock device for bicycle, which comprises an outer cylinder of a frame, an inner cylinder of front fork, and a transmission assembly mounted between the aforesaid parts; the transmission assembly includes a fixed member, which has a transverse cylindrical hole for receiving a lock device; the outer surface of the lock cylinder of the lock device is furnished with a gear portion; a key is plugged into the keyhole of the lock device to push a plurality of tumbler disks to move; the engage surface of the key can drive the outer casing to turn, and then the gear portion of the outer casing will actuate the transmission assembly to move so as to have the frame and the front fork locked up at an angle of 45 degrees.

### BACKGROUND OF THE INVENTION

1. Field of the Invention

This invention relates to a lock device, and particularly to a lock device to be unlocked by rotating an outer casing to actuate the transmission assembly.

2. Description of the Prior Art

In the conventional lock device, it usually comprises a plurality of tumbler balls or tumbler disks mounted between the inner casing and the outer casing of the lock cylinder; after a key is plugged into the key hole, the tumbler balls or tumbler disks will be pushed to move so as to have a detent structure between the inner casing and the outer casing released; when the key is turned, the lock cylinder will be driven directly to turn so as to actuate a connector to rotate or pull for unlocking or locking up.

In the conventional lock device for bicycle, the lock device is usually mounted at a connection part between the rear fork and the control support shaft; the lock device has a C-shaped opening to mount across both sides of the rim of a wheel; the lock has a push bar to push a lock bar across the inner side of the steel rim; after the lock bar is set at the lock-up position, the wheel can not be moved; the aforesaid technique can not be used to a bicycle, which is designed for running in fields.

In the conventional lock device for bicycle, some bicycles can not be locked up with a built-in type of lock as a result of the type of bicycle varied continuously; consequently, an external type of lock (such as U-shaped lock, steel cable lock, etc.) must be used. An external type of lock, such as a U-shaped lock, may be attached to the support shaft of the frame upon being unlocked, i.e., it can be plugged in a fixed member. If other types of lock are used, they must occupy additional space of the bicycle.

### SUMMARY OF THE INVENTION

The prime object of the present invention is to provide an improved lock device in accordance with a patent application; “Cylinder-Pushing Type of Lock Device” was filed, in which the lock cylinder is fastened fixedly to a fixed member. The outer casing of the lock device can be turned upon a key plugged to rotate.

Another object of the present invention is to provide a lock device for bicycle, in which the lock device is mounted in a cylindrical hole of the fixed member, and then the positioning bar at the tail end of the lock cylinder will be plugged into a positioning hole so as to have the lock cylinder fixed in the fixed member. When a key is plugged in and turned for unlocking, the outer casing will be driven to rotate.

Still another object of the present invention is to provide a lock device for bicycle, in which the central cylindrical hole of the lock cylinder has a vertical groove on one side thereof; both sides of the vertical groove are furnished with two inner groove surfaces and two outer groove surfaces respectively. The inner groove surfaces of the vertical groove are to be engaged with the positioning plates of the tumbler disks so as to have the tumbler disks moved along the surface of the vertical groove upon being pushed with a key.

A further object of the present invention is to provide a lock device for bicycle, in which one side of the central cylindrical hole of the lock cylinder has a vertical groove; both sides of the vertical groove are furnished with inner groove surfaces and outer groove surfaces respectively; both sides of the outer groove surfaces of the vertical groove and the both sides of the retaining plates of the tumbler disks form into two longitudinal receiving grooves; one of the longitudinal receiving grooves is used for receiving a salient block projected into the central cylindrical hole of the outer casing; before the key pushing the tumbler disks and the salient blocks thereof moving to the corresponding grooves, the key is unable to turn the outer casing; as soon as the key pushes all the tumbler disks to the corresponding grooves, the key can driven the outer casing to rotate, and the grooves of the salient block would not hinder the retaining plates of the tumbler disks until the salient block moving into another receiving groove; then, the outer groove surface of the vertical groove will hinder the move of the outer casing, i.e., the outer casing can only turn within an angle desired for unlock in the lock device.

A still further object of the present invention is to provide a lock device for bicycle, in which the central cylindrical hole in the outer casing is furnished with a mortise for receiving a tenon; the salient block of the tenon extends into the cylindrical hole. The salient block has a plurality of transverse grooves. The key is furnished with a plurality of push surfaces, of which the distance among them must be fit and corresponding to that among the transverse grooves. When a key is pushing the tumbler disks, the tumbler disks must be pushed to the corresponding transverse grooves before unlocking the lock device.

Yet another object of the present invention is to provide a lock device for bicycle, in which each of the tumbler disks includes a retaining ring, a positioning ring and a guide ring; the diameter of the guide ring is equal to or slightly less than that of the central cylindrical hole of the lock cylinder so as to facilitate the tumbler disks to move smoothly in the cylindrical hole of the lock cylinder. The positioning ring is mounted between the retaining ring and the guide ring, and it includes a ring-shaped groove and a balance spring. The retaining ring has an outer cylindrical surface similar to that of the guide ring, a positioning plate and a retaining plate. The tumbler disks are mounted in the central cylindrical hole of the lock cylinder; the balance spring can provide the cylindrical hole of the lock cylinder with a resilient contact so as to have the tumbler disks moved steadily along the cylindrical hole upon being pushed by the key.

Yet still another object of the present invention is to provide a lock device for bicycle, in which the key hole of the outer casing has a hole to be engaged with the engaged surface of the key; after the key is plugged into the key hole to turn, the engage surface will drive the outer casing to turn for unlocking.

Yet a further object of the present invention is to provide a lock device for bicycle, in which a transmission assembly is mounted between the outer cylinder of the frame and the inner cylinder of the front fork; the lock device is fixed by mounted in a cylindrical hole of a fixed member. When the frame and the front fork are set at an angle of 45 degrees, the key can be plugged into the key hole, and turned so as to drive the gear portion of the outer casing to rotate and to drive the transmission assembly to move; then, the frame and the inner cylinder of the front fork will be locked up.

Yet a still further object of the present invention is to provide a lock device for bicycle, in which one side of the fixed member is furnished with a guide groove for receiving a sliding block; the inner side of the sliding block has a gear rack to be engaged with the gear portion of the outer casing; the sliding block is directly driven to move with the gear portion of the outer casing; the other end of the sliding block has a short shaft extended into the cylindrical hole of the fixed member and connected with a round shaft therein. To lock the lock device with a key, the gear portion on the outer casing will driven the sliding block to move, and round shaft in the cylindrical hole of the fixed member will also be moved, and then the frame and the front fork will be locked up.

Yet a still more further object of the present invention is to provide a lock device for bicycle, in which both sides of the cylindrical hole of the fixed member are furnished two symmetrical through holes, and the long cylindrical hole is loaded with a round shaft having a round groove; one side of the round shaft is connected with the sliding block. The spaces between the round groove of the round shaft and the cylindrical holes of the fixed member are loaded with two steel balls respectively; when the lock device is unlocked, the steel balls in the symmetrical spaces of cylindrical holes of the fixed member are set freely in the round groove of the round shaft; in that case, the frame and the front fork can be rotated freely. When the frame and the front fork are locked up, the round shaft in the fixed member will be pushed by the sliding block to move downwards, and the steel balls in the round groove of the round shaft will be pushed out and limited in a space formed with the round hole of the fixed member, the through hole of the inner cylinder and the positioning hole of the outer cylinder, being unable to move, i.e., the outer cylinder and the inner cylinder are locked together to set the frame and the front fork at an angle of 45 degrees.

Yet an additional further object of the present invention is to provide a lock device for bicycle, in which the round shaft is mounted in the long cylindrical hole of the fixed member, and the lower end of the round shaft is pushed with a cylindrical spring so as to provide the round shaft with a inward pushing force; the other end of the cylindrical spring has a large spring ring to be mounted in a ring groove for positioning the spring.

### BRIEF DESCRIPTION OF THE DRAWINGS

FIG. 1 is a fragmental view of a bicycle, showing a position of the present invention to be mounted.

FIG. 2 is a disassembled view of the lock device and a key thereof according to the present invention.

FIG. 3 is a disassembled view of the lock device according to the present invention.

FIG. 4 is a sectional view of the present invention, showing the lock device under locked condition.

FIG. 5 is a sectional view of the present invention, showing the lock device under unlocked condition.

FIG. 6 is a sectional view of the present invention, showing the structure relation among the lock device, the transmission assembly, the frame and the front fork.

FIG. 7 is a sectional view of the present invention, showing the frame and the front fork locked up at an angle of 45 degrees.

FIG. 8 is a sectional view of the present invention, showing the lock device under locked condition.

FIG. 9 is a sectional view of the present invention, showing the tumbler disks being driven to unlocked position.

FIG. 10 is a sectional view of the present invention, showing the outer casing being driven to turn.

FIG. 11 is a sectional view of the present invention, showing the outer casing being moved to an end of the lock device.

FIG. 12 is a sectional view of the present invention, showing the transverse structure of FIG. 8.

FIG. 13 is a sectional view of the present invention, showing the transverse structure of FIG. 11.

FIG. 14 is a disassembled view of the present invention, showing the structure of the transmission assembly.

FIG. 15 is a sectional view of the present invention, showing the frame and the front fork under disengaged condition.

### DETAILED DESCRIPTION OF THE PREFERRED EMBODIMENT

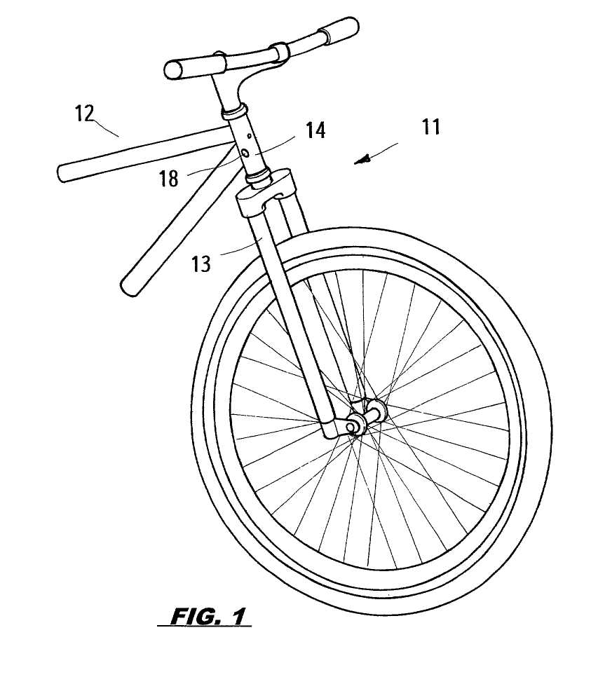

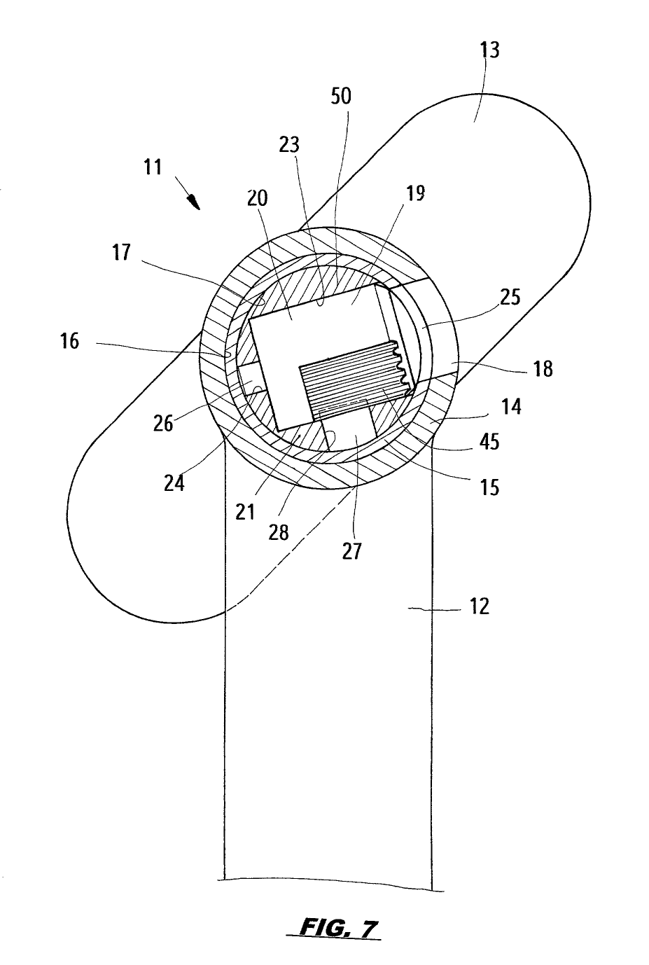

This invention relates to a lock device for bicycle (or bike); as shown in FIGS. 1 to 3, 6 and 7, a pivotal shaft structure is furnished between the frame 12 and the front fork 13. A lock device 20 is mounted in a cylindrical hole 23 of the fixed member 21; the tail end of the lock cylinder 51 is plugged into a positioning hole 24 of the cylindrical hole 23. After a key 49 is plugged into a keyhole 48 of the lock device 20, the key 49 can drive the lock device 20 to rotate; then, the gear portion 45 on the outer casing 19 will pull a sliding block 27 and a round shaft 31 to move so as to have the front fork 13 and the frame 12 locked up at an angle of 45 degrees.

The lock device 20 mounted in the cylindrical hole 23 of the fixed member 21 comprises an outer casing 19, a lock cylinder 51, a main spring 52, a tenon 53 and a plurality of tumbler disks 54. The outer casing 19 has a gear portion 45; one end of the outer casing has a cylindrical hole 60, while the other end thereof has a keyhole 48. The surface of the cylindrical hole 60 is furnished with a mortise groove 61. The cylindrical hole 60 is mounted with a lock cylinder 51, a main spring 52 and a plurality of tumbler disks 54. The mortise groove 61 is loaded with a tenon 53, and the salient block 58 extends into the cylindrical hole 60.

One end of the lock cylinder 51 is furnished with a cylindrical hole 80, of which one side is furnished with a vertical groove 81, and both sides thereof are furnished with inner and outer groove surfaces 82 and 83 respectively, having different width; the other end of the lock cylinder 51 has a positioning bar 26, which includes a short bar and two symmetrical flat surfaces. The cylindrical hole 80 in the lock cylinder 51 is loaded with a main spring 52 and a plurality of tumbler disks 54. After the lock cylinder 51 is mounted in the cylindrical hole 60 of the outer casing 19, the main spring 52 will push the tumbler disks 54 upwards to the highest surface of the cylindrical hole 60. Each of the tumbler disks 54 in the cylindrical hole 80 has a sector positioning plate 76 and sector retaining plate 77 on one side thereof, which engage with the inner groove surface 82 and the outer groove surface 83 respectively in the vertical groove 81; the positioning bar 26 at one end of the lock cylinder 51 is plugged into the positioning hole 24 in the cylindrical hole 23 of the fixed member 21 so as to have the lock cylinder 51 and the fixed member 21 assembled together as one piece.

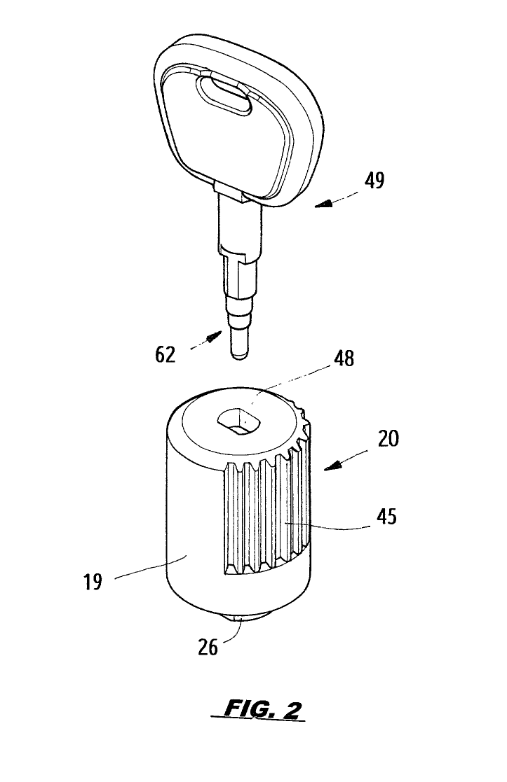

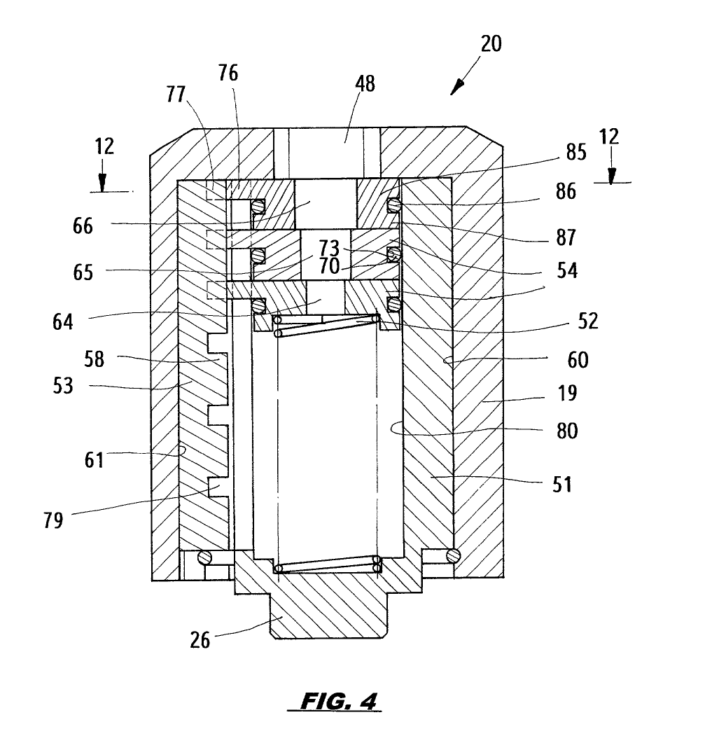

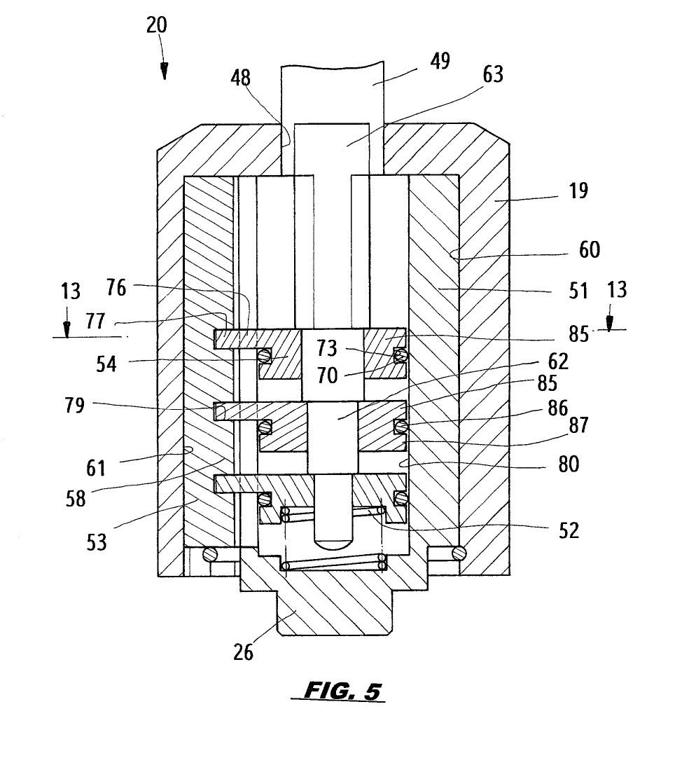

As shown in FIGS. 2 to 8, each of the tumbler disks 54 in the central cylindrical hole 80 is furnished with a cylindrical hole 64 (or 65, 66), which has different diameter so as to mate with the diameter of the cylindrical key surface 62 of the key 49, and to facilitate the push surface of the cylindrical key surface 62 to push the tumbler disks 54 to an unlock position; every tumbler disk 54 includes a retaining ring 85, a positioning ring 86 and a guide ring 87; the positioning ring 86 is mounted between the retaining ring 85 and the guide ring 87; it also includes a ring groove 73 and a balance spring 70. The heights of the retaining ring 85 and the guide ring 87 are equal; the ring groove 73 is furnished between the retaining ring 85 and the guide ring 87, and is mounted with a balance spring 70.The diameter of the retaining ring 85 and the guide ring 87 is equal to or slightly smaller than that of the central cylindrical hole 80. When the tumbler disks 54 are pushed by the cylindrical key surfaces 62 of the key 49, the tumbler disks 54 will move along the cylindrical hole 80 in a balance manner; the ring groove 73 between the retaining ring 85 and the guide ring 87 is mounted with a balance spring 70, which is in contact with the cylindrical hole 80 of the lock cylinder 51. The balance spring 70 is substantially a wire spring with an opening, and it may be an O-ring made of rubber, which is in contact with the cylindrical hole 80 of the lock cylinder 51; it will be moved upon being pushed with the push surface of the cylindrical key surface 62 of the key 49. When the key 49 is pulled out, a friction force between the balance spring 70 of each tumbler disk 54 and the cylindrical hole 80 of the lock cylinder 51 is not large, i.e., such friction force would not hinder the tumbler disks 54 to return to the normal position upon being pushed with the main spring 52. On the contrary, the balance spring 70 of every tumbler disk 54 will provide a steady displacement upon being pushed along the cylindrical hole 80 of the lock cylinder 51. Since every tumbler disk 54 has to be pushed by the round push surface of a key 49, any incorrect key 49 will be unable to push the tumbler disks 54 in a steady manner, and any small tilt of the key would cause a failure to unlock the lock device.

The retaining ring 85 and the guide ring 87 on each tumbler disk 54 in the cylindrical hole 80 can provide a steady and guide function during moving; the balance spring 70 mounted in the ring groove 73 between the retaining ring 85 and the guide ring 87 can provide a linear contact with the cylindrical hole 80 so as to have every tumbler disk 54 had a steady displacement.

One side of every tumbler disk 54 has a sector positioning plate 76 and a retaining plate 77; the sector angle of the positioning plate 76 is larger than that of the retaining plate 77. After the tumbler disk 54 is mounted in the cylindrical hole 80 of the lock cylinder 51, the positioning plate 76 of the retaining ring 85 will be located across the inner groove surface 82 of the vertical groove 81 of the vertical groove 81; both sides of the positioning plate 76 will be in close contact with the inner groove surface 82; then, the retaining plate 77 will be located across the outer groove surface 83 of the vertical groove 81 of the lock cylinder 51. The width of the outer groove surface 83 is larger that of the inner groove surface 82; the sector angle of the retaining plate 77 is smaller than that of the positioning plate 76. Between the retaining plate 77 and the outer groove surface 83, there is a receiving groove 84 formed on both sides of the sector positioning plate 76; the receiving grooves include a receiving groove 84A and a receiving groove 84B; the receiving groove 84A is used for receiving a salient block 58 of a tenon 53 in the cylindrical hole 60 of the outer casing 19 upon the lock device 20 being in locked up condition; the other receiving groove 84B is used for receiving the tenon 53 in the cylindrical hole 60 so as to limit the rotating angle of the outer casing 19 upon the lock device 20 being in unlocked condition.

The central cylindrical hole 61 of the outer casing 19 is furnished with a dovetail mortise groove 61 to be mated with a dovetail tenon 53, and it is furnished in the cylindrical hole 60 of the outer casing 19 fixedly. The tenon 53 includes a dovetail block 90 and a salient block 58; the salient block 58 is mounted between the outer groove surface 83 of the vertical groove 81 and the retaining plate 77 of the tumbler disk 54; the height of the salient block 58 is slightly less than that of the outer groove surface 83 of the vertical groove 81; the width of the salient block 58 is slightly less than that of the receiving groove 84A (or 84B). The salient block 58 is furnished with a plurality of transverse grooves 79 in accordance with the number of the tumbler disks 54; the height of the transverse grooves 79 is slightly larger than the thickness of the retaining plate 77 of the tumbler disk 54. When the key 49 pushes the tumbler disks 54 to a position opposite to the transverse grooves 79 of the salient block 58, turn the key 49 so as to actuate the outer casing 19 to move and to unlock the lock device. The salient block 58 in the central cylindrical hole 60 of the outer casing 19 would not be hindered by the retaining plates 77 of the tumbler disks 54; after the grooves 79 move and slide over the retaining plates 77 of the tumbler disks 54, the outer casing 19 will be turned to actuate the transmission member to displace.

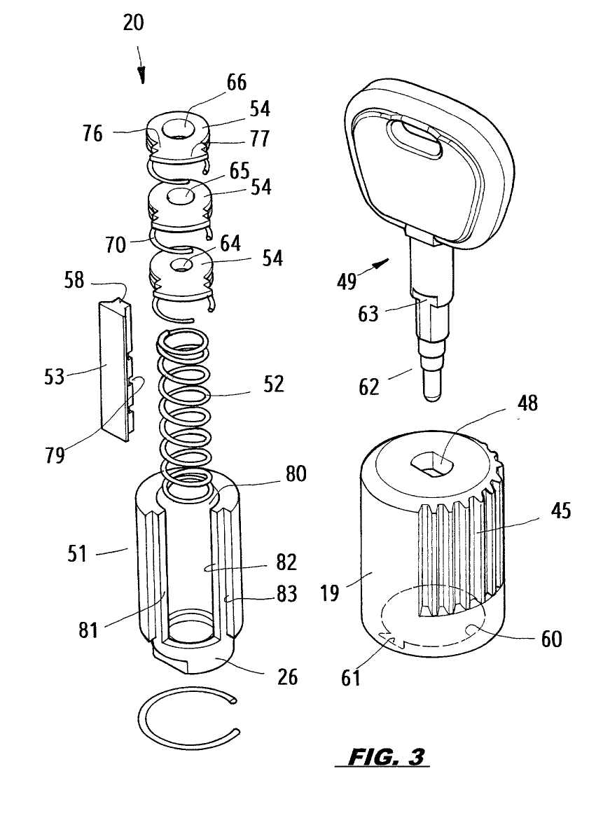

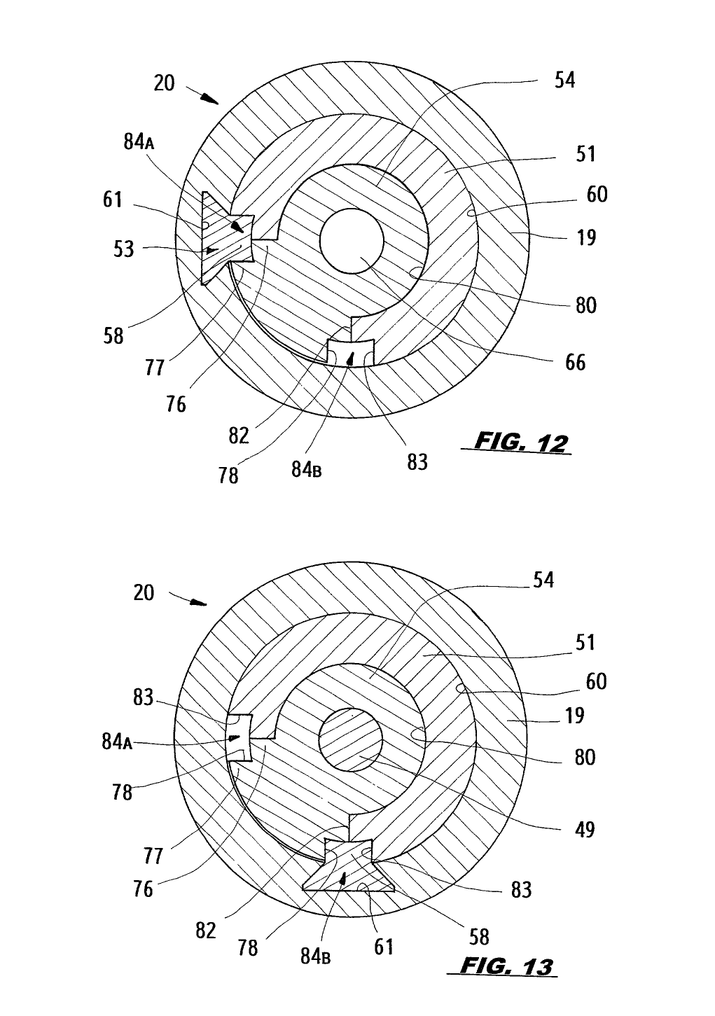

As shown in FIGS. 3, 4, 7, 8 and 12, the lock device 20 is mounted in a cylindrical hole 23 of a fixed member 21; before the lock device 20 is unlocked, all the tumbler disks 54 are pushed with a main spring 52, and almost in contact with one another nearing the top surface of the cylindrical hole 60. One end of the cylindrical hole 60 is furnished with a key hole 48. The positioning plate 76 on the tumbler disk 54 is engaged with the inner groove surface 82 of the vertical groove 81 in the lock cylinder 51 so as to provide a positioning function. The retaining plate 77 of the tumbler disk 54 has a sector angle, which is smaller than that of the positioning plate 76. All the side surfaces 78 on both sides of the retaining plate 77 of all the tumbler disks 54 are aligned so as to form into two receiving grooves 84A and 84B by means of the two outer groove surfaces 83 on both sides of the vertical groove 81. The size of the two receiving grooves 84A and 84B is so designed as to fit the size of the salient block 58 projected into the cylindrical hole 60. When the lock device 20 is locked up, the salient block 58 is retained in the receiving groove 84A; after the lock device 20 is unlocked, the salient block 58 is moved into the receiving groove 84B.

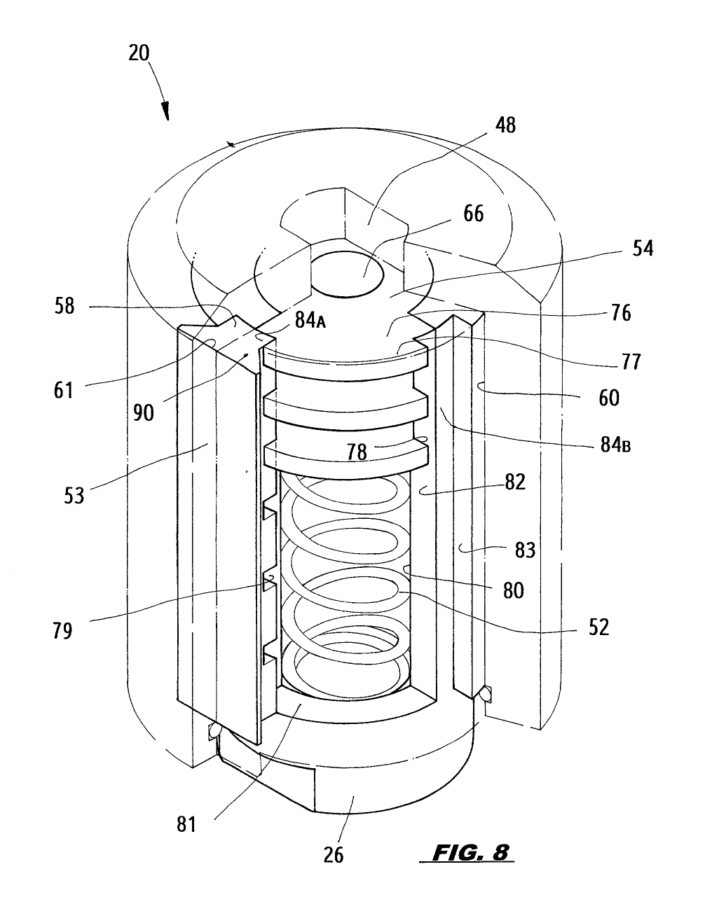

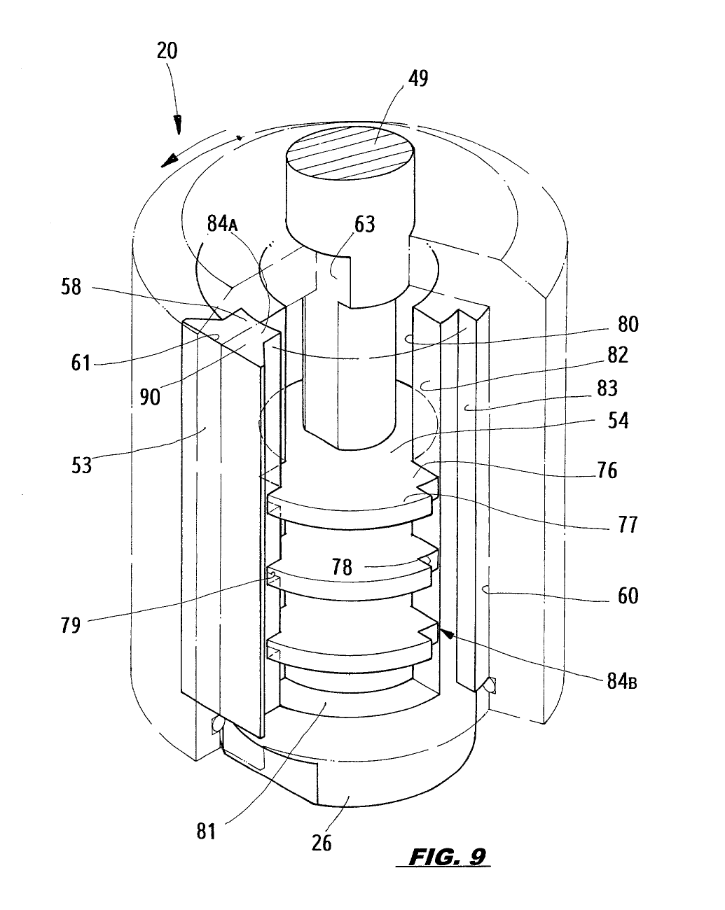

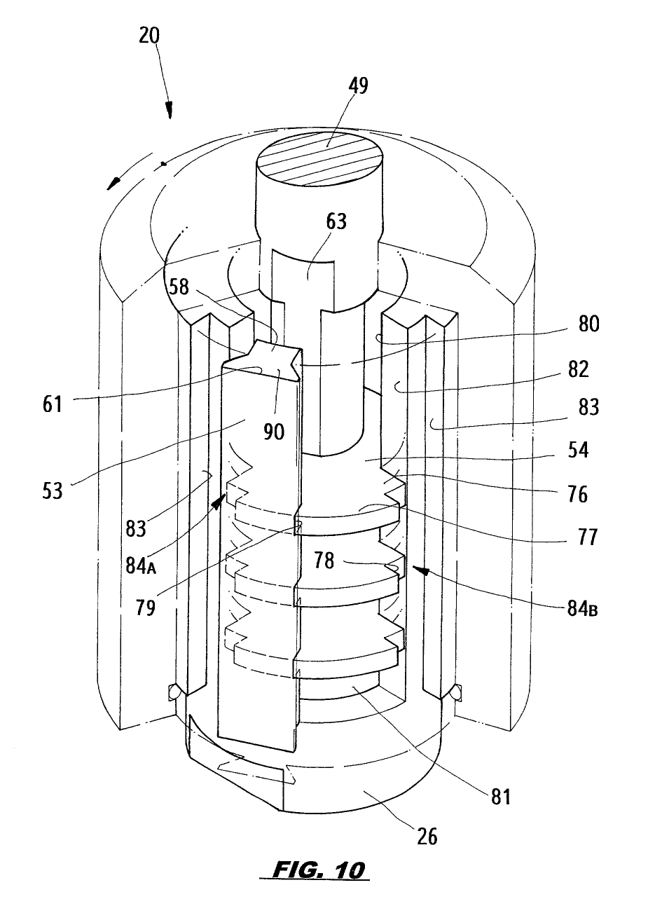

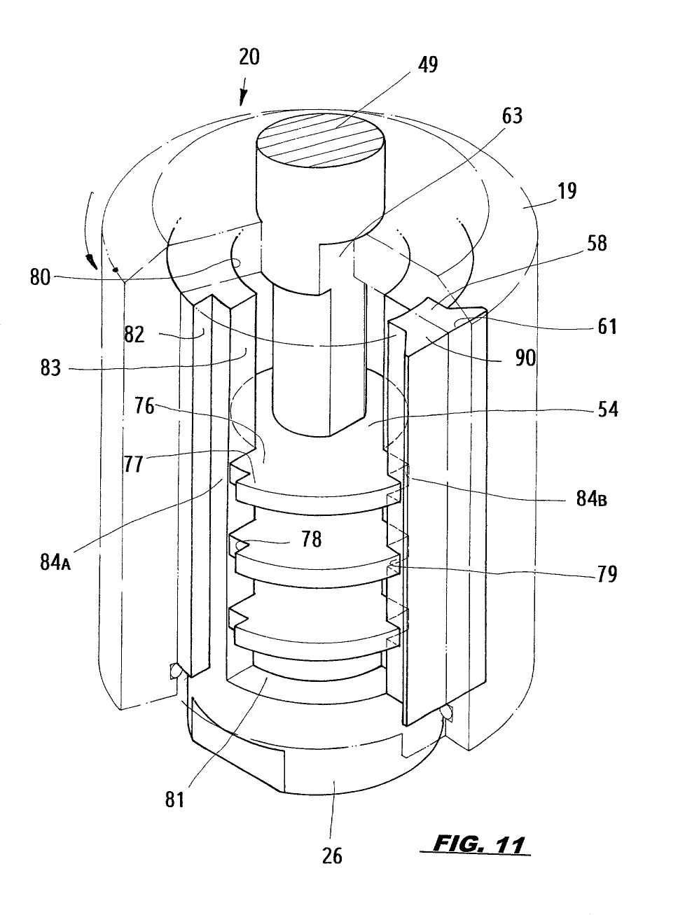

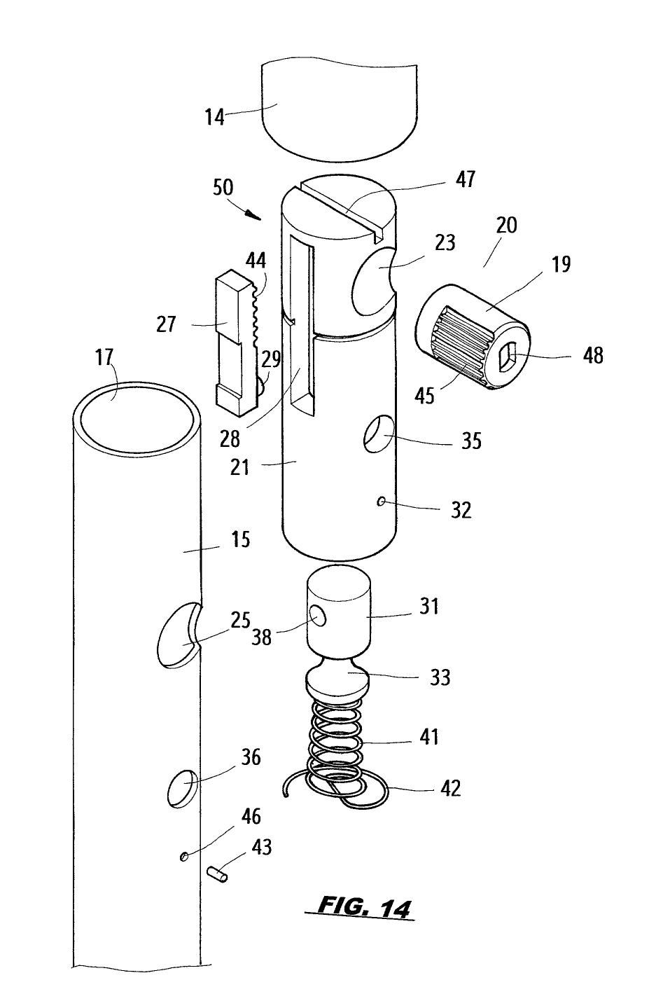

Referring to FIGS. 8 to 11, before the key 49 is plugged into the key hole 48, all the tumbler disks 54 are pushed with the main spring 52; in that case, the outer groove surface 83 of the retaining plate 77 of every tumbler disk 54 hinders the salient block 58 to displace. After the key 49 is plugged into the key hole 48 of the outer casing 19, the engage surface 63 of the key 49 will be mated with the key hole 48; in that case, if merely one of the tumbler disks 54 is unable to face the corresponding groove 79 of the salient block 58, the lock device 20 will still be in locked condition. As soon as the key 49 is plugged into the key hole 48 (As shown in FIG. 9), the engage surface 63 of the key 49 will mate with the key hole 48; then, the cylindrical key surface 62 of the key will push all the tumbler disks 54 to a position corresponding to the grooves 79 respectively; the key 49 can drive the outer casing 19 to turn (as shown in FIG. 10), and the key 49 continues to turn, as shown in FIGS. 11 and 13; in that case, the salient block 58 will only be driven to another receiving groove 84B, and then the salient block 58 will be hindered by the outer groove surface 83, and the lock device 20 is unlocked. After the key 49 is pulled out, the salient block 58 in the cylindrical hole 60 has been moved from the receiving groove 84A to the receiving groove 84B; then, the gear portion 45 on the outer casing 19 will drive the transmission assembly to move.

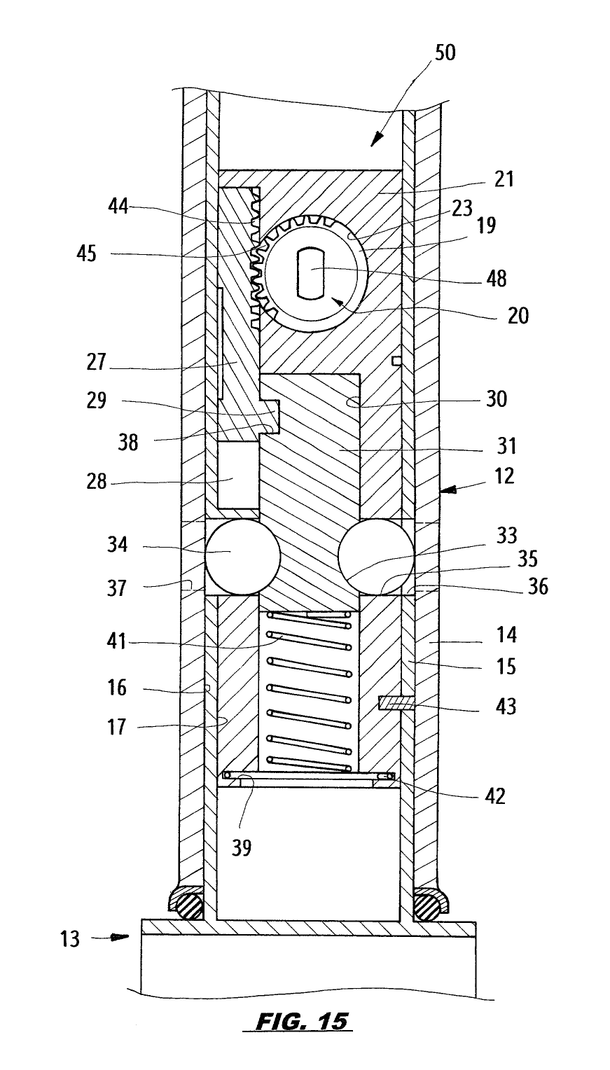

As shown in FIGS. 1, 6, 7, 14 and 15, the outer casing is used for unlocking the lock device 20 mounted in the front fork 13 of a bike; the lock device is mounted in a transverse cylindrical hole 23 of a transmission assembly 50, which is mounted in the inner cylinder 15 of the front fork 13 of a bike 11; the key hole 48 of the lock device 20 faces outwards; after the key 49 is plugged therein, the tumbler disks 54 will be pushed to move and turn; then, the gear portion 45 of the outer casing 19 will actuate the sliding block 27 furnished with a gear rack; then, a round shaft 31 at one end of the fixed member 21 will be moved to push the steel balls 34 in the round groove 33 to move outwards; finally, the steel balls 34 will be caught in the round hole 35 of the fixed member 21, the through hole 36 of the inner cylinder 15 of the front fork 13, and the positioning hole 37 of the outer cylinder 14 of frame 12; then, the frame 12 and the front fork 13 will be set at an angle of 45 degrees.

The transmission assembly 50 mounted in the inner cylinder 15 of the front fork 13 of the bike 11 includes a fixed member 21, a lock device 20, a sliding block 27, a round shaft 31, steel balls 34 and a cylindrical spring 41; one end of the fixed member 21 is furnished with a transverse cylindrical hole 23 having a positioning hole 24, and the transverse cylindrical hole 23 is used for receiving a lock device 20; the tail end of the lock cylinder 51 has a positioning bar 26 to be plugged into the positioning hole 24. One side of the fixed member 21 is furnished with a guide groove 28 which is in communication with a transverse cylindrical hole 23 mounted with a lock device 20; the lower part of the guide groove 28 is in communication with the central cylindrical hole 30 of the fixed member 21; the guide groove 28 is mounted with a sliding block 27. The central part of the fixed member 21 has a cylindrical hole 30; both sides of the cylindrical hole 30 are furnished with symmetrical round holes 35. The lower end of the cylindrical hole 30 has a ring groove 39. The outer surface of the fixed member 21 is furnished with at least one cotter hole 32, which is used for fastening the inner cylinder 15 and the fixed member 21 together after the lock device 20 being mounted in the inner cylinder 15 of the front fork 13.

After the lock device 20 is mounted in the transverse cylindrical hole 23 of the fixed member 21, a positioning bar 26 on the tail end of the lock cylinder 51 will be set in a positioning hole 24 of the transverse cylindrical hole 23 so as to have the lock device 20 and the fixed member 21 fastened together. The surface of the outer casing 19 has a gear portion 45. When the key 49 turns the lock device 20 for unlock, the key 49 will directly actuate the gear portion 45 of the outer casing 19 to turn so as to drive the sliding block 27 to move along the guide groove 28.

The sliding block 27 is mounted in a guide groove 28 on one side of the fixed member 21, and the inner side thereof is furnished with a gear rack 44; the outer side thereof has a curved surface corresponding to the curve of the fixed member 21. Inner side of one end of the sliding block 27 has a short shaft 29 to be plugged into a cylindrical hole 38 on the round shaft 31 in the cylindrical hole 30 of the fixed member 21 so as to actuate the round shaft 31 to move synchronously.

The round shaft 31 mounted in the central cylindrical hole 30 of the fixed member 21 is furnished with a transverse cylindrical hole 38 for linking the short shaft 29 on one end of the sliding block 27 with the round shaft 31; the other end of the round shaft 31 is furnished with a round groove 33, which is designed in accordance with the diameter of the steel ball 34; the round groove 33 has a curved space approximately to the radius of a steel ball 34. The round shaft 31 is to be mounted in the cylindrical hole 31 of the fixed member 21; the round groove 33 of the round shaft 31 is just apposite to the round holes 35 on both sides of the cylindrical hole 30; the steel balls 34 are mounted in a space between the round groove 33 and the cylindrical hole 30 of the fixed member 21.

The cylindrical spring 41 has a diameter slightly less than that of the central cylindrical hole 30 of the fixed member 21, and is mounted in the cylindrical hole 30; one end of the spring 41 is pushing against the bottom of the round shaft 31 so as to provide the round shaft 31 with a pushing-up force; when the lock device 20 is unlocked, the cylindrical spring 41 will push the round shaft 31 upwards. The lower end of the spring 41 has a spring ring 42 with a larger diameter to be retained in a groove 39 on one end of the fixed member 21 so as to provide the cylindrical spring 41 with better positioning and pushing up force.

When assembling the lock device, the round shaft 31 is first mounted in the central cylindrical hole 30 of the fixed member 21, and the lower end of the round shaft 31 is pushed and positioned in place with the cylindrical spring 41. The cylindrical hole 38 of the round shaft 31 faces the guide groove 28 so as to engage with the short shaft 29 of the sliding block 27; the upper end of the gear rack 44 extends into the transverse cylindrical hole 23 so as to engage with the gear position 45 of the outer casing 19 of the lock device 20.

The lock device 20 is pushed in place through the central cylindrical hole 16 of the inner cylinder 15 of the front fork 13 by using a straight tool until touching the groove 47 on the fixed member 21; then, push and adjust it so as to push the fixed member 21 to a desired position in the cylindrical hole 17 of the inner cylinder 15; the cylindrical hole 35 of the fixed member 21 should be aligned with the through hole 36 of the inner cylinder 15. After the fixed cotter 43 is plugged into the cotter hole 46 of the inner cylinder 15, the other end of the fixed cotter 43 will extend into the cotter hole 32 of the fixed member 21 so as to have the fixed member 21 fixedly mounted in the cylindrical hole 17 of the inner cylinder 15. After the lock device 20 is mounted in the cylindrical hole 23 of the fixed member 21 transversely, the keyhole 48 will face and a align with the key-guide hole 25 in the inner cylinder 15.

When the inner cylinder 15 of the front fork 13 of a bike 11 is assembled with the frame 12, the lower end of the inner cylinder 15 should first be mounted with other parts, such as roller seat and rollers; then, the outer cylinder 14 of the frame 12 is mounted over the inner cylinder 15 of the front fork 13; before the aforesaid mounting-over operation, two steel balls 34 must be mounted in the through holes 36 of the inner cylinder 15; the outer cylinder 14 of the frame 12 is mounted over the inner cylinder 15 of the front fork 13 and other parts so as to complete the assembling operation of the lock device 20.

The lock device 20 mounted in the inner cylinder 15 of the front fork 13 can be turned together with the front fork 13. After the front fork 13 is turned at an angle of 45 degrees from the frame 12, the steel balls 34 in the through hole 36 of the inner cylinder 15 and in the round hole 35 of the fixed member 21 will be moved into the positioning hole 37 in the outer cylinder 14 of the frame 12. The key-guide hole 25 in the front fork 13 will be aligned with the key hole 18 in the frame 12 so as to facilitate a key 49 to plug in for unlocking the lock device 20.

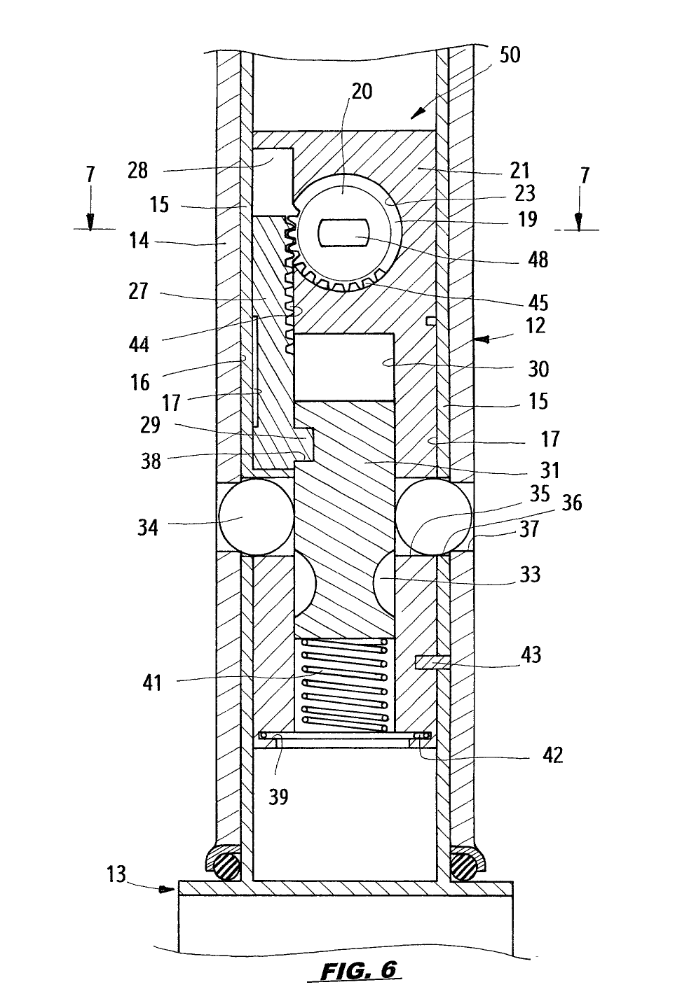

The sliding block 27 on the round shaft 31 in the cylindrical hole 30 of the fixed member 21 would not moved before the key being plugged in as shown in FIG. 15; the steel balls 34 mounted in the round groove 33 of the round shaft 31 and in the cylindrical hole 35 of he fixed member 21 can move freely along the inner surface of the outer cylinder 14 of the frame 12, and the front fork 143 and the frame 12 would not have locked condition; as shown in FIG. 6, the positioning hole 37 in the outer cylinder 14 of the frame 12 will be aligned with the through hole 36 of the inner cylinder 15 upon the key-guide hole 25 of the front fork 13 being turned to the position of the key hole 18 of the frame 12; in such case, the steel balls 34 will have more space to move. When the key is plugged in to unlock the lock device 20, the gear portion 45 on the outer casing 19 will actuate the sliding block 27 to move so as to drive the round shaft 31 in the central cylindrical hole 30 to displace; then, the steel balls 34 in the round groove 33 of the round shaft 31 will be pushed to move outwards, and finally the steel balls 34 will be pushed into a space among the round hole 35 of the fixed member 21, the through hole 36 of the inner cylinder 15, and the positioning hole 37 of the outer cylinder 14; the round surface of the round shaft 31 is used for limiting the motion of the steel balls 34, i.e., the steel balls 34 are retained between the outer cylinder 14 of the frame 12 and the inner cylinder 15 of the front fork 13 so as to have the frame 12 and the front fork 13 locked up.

To unlock the device, the key should be plugged into the keyhole 48 and turned; then, the gear portion 45 of the outer casing 19 will actuate the sliding block 27 to pull the round shaft 31 to move upwards; then, the round groove 33 of the round shaft 31 will return to a position opposite to the round hole 35 so as to have the steel balls 34 had more moving space; after the key is pulled out, the frame 12 and the front fork 13 will restore to a free rotation condition.

According to the aforesaid description of the embodiment, the structure between the salient block 58 in the cylindrical hole 60 of the outer casing 19 of the lock device 20 and the plural tumbler disks 54 has been disclosed completely; after the key 49 is plugged into the key hole 48 of the outer casing 19, it will push every tumbler disk 54 in the cylindrical hole to move to a position opposite to a corresponding groove 79 of the salient block 58; when turn the key 49, the outer casing 19 will be driven to rotate; then, the gear position 45 of the outer casing will drive the transmission assembly 50 to move so as to have the frame 12 and the front fork 13 locked up at an angle of 45 degrees. Since the structural relation of the embodiment thereof has been disclosed completely, it is apparent that the present invention has provided a clear and obvious improvement, which is never anticipated and achieved by any person in the field, and therefore it is deemed unique in terms of structure.

What is claimed is:

1. A lock device to be unlocked by rotating an outer casing comprising:
an outer casing with a cylindrical hole, and surface of said cylindrical hole having a mortise groove for receiving a tenon which having a salient block extended into said cylindrical hole; said cylindrical hole of said outer casing to be mounted with a lock cylinder and other parts;
a tenon being a dovetails-shaped tenon to be plugged in said mortise groove;
a lock cylinder having a positioning bar at one end thereof to be plugged in a positioning hole, while other end thereof having a cylindrical hole with a vertical groove on one side thereof, and both sides of said vertical groove furnished respectively with sector-shaped inner groove surface and outer groove surface in different curves; said cylindrical hole mounted with a main spring and a plurality of tumbler disks; every said tumbler disk having a positioning plate and a retaining plate to be placed across said vertical groove;
a plurality of tumbler disks, of which each having a cylindrical hole for receiving a key, and one outer edge thereof furnished with a positioning plate and a retaining plate to be placed across said vertical groove; and a main spring mounted in cylindrical hole of said lock cylinder.

2. A lock device to be unlocked by rotating an outer casing as claimed in claim 1, wherein outer end of said outer casing is furnished with a key hole, and said keyhole to be mated with an engage surface of a key; said lock device able to be unlocked by using a key to turn said outer casing.

3. A lock device to be unlocked by rotating an outer casing as claimed in claim 1, wherein outer surface of said outer casing has a gear portion, which being turned upon a key used for unlocking said lock device.

4. A lock device to be unlocked by rotating an outer casing as claimed in claim 1, wherein said lock cylinder has a vertical groove, of which both sides furnished with an inner groove surfaces and an outer groove surfaces respectively having different width, and sector angle of said inner groove surface being less than that of said outer groove surface.

5. A lock device to be unlocked by rotating an outer casing as claimed in claim 1, wherein said inner groove surface of said vertical groove is used for receiving a positioning plate of said tumbler disk, and both sides of said positioning plate being in close contact with both sides of said outer groove surface; said outer groove surface of said vertical groove used for receiving said retaining plate; both sides of said retaining plate and both sides of said outer groove surfaces formed into two receiving grooves respectively, which are used for receiving a salient block extended into said cylindrical hole of said outer casing.

6. A lock device to be unlocked by rotating an outer casing as claimed in claim 1, wherein said salient block of said tenon projected in said cylindrical hole of said outer casing has a height being slightly less than that of said outer groove surface of said vertical groove; width of said salient block being slightly less than that from groove surface of said vertical groove to side surface of said retaining plate of said tumbler disk.

7. A lock device to be unlocked by rotating an outer casing as claimed in claim 1, wherein said salient block of said tenon projected in said cylindrical hole in said outer casing is furnished with a plurality of transverse grooves corresponding number of said tumbler disks; thickness of each said transverse groove being slightly larger than that of said retaining plate.

8. A lock device to be unlocked by rotating an outer casing as claimed in claim 1, wherein every tumbler disk of said lock device includes:
a retaining ring being a short ring mounted in cylindrical hole of said lock cylinder, and outer edge thereof furnished with a sector-shaped positioning plate and a retaining plate;
a positioning ring mounted between said retaining ring and a guide ring, and a balance spring mounted therein to be in contact with said cylindrical hole of said lock cylinder; and
a guide ring having same height as that of said retaining ring, and having a short ring surface mounted in said cylindrical hole of said lock cylinder.

9. A lock device mounted in front-fork shaft of a bicycle comprising:
a fixed member having a transverse cylindrical hole on upper end thereof for receiving said lock device, and one side thereof having a guide groove for receiving a sliding block furnished with a gear rack; said guide groove being in communication with a cylindrical hole of said lock device; lower end of said guide groove being in communication with said cylindrical hole of said fixed member; other end of said fixed member furnished with a cylindrical hole, of which both sides furnished with through round holes respectively;
a lock device, of which outer casing having a gear portion; said lock device mounted in a transverse cylindrical hole of said fixed member; a lock cylinder assembled together with said fixed member; said gear portion engaged together with said gear rack of said salient block;
a sliding block mounted in a guide groove of said fixed member; upper part of said sliding block having a gear rack to be engaged with a gear portion on said outer casing, and lower part thereof having short shaft to be connected with a round shaft in cylindrical hole of said fixed member;
a round shaft mounted in a cylindrical hole in one end of said fixed member, and having a round groove on surface thereof;
a cylindrical spring mounted in a cylindrical hole at one end of said fixed member, and one end of said cylindrical spring pushing against outer end of said round shaft; and
two steel balls mounted in round holes in mid-part of a cylindrical hole of said fixed member.

10. A lock device mounted in front-fork shaft of a bicycle as claimed in claim 9, wherein said fixed member is mounted in an inner cylinder of front fork of said bicycle; said inner cylinder having through hole corresponding to round hole in said fixed member.

11. A lock device mounted in front-fork shaft of a bicycle as claimed in claim 9, wherein a transverse cylindrical hole on upper part of said fixed member is furnished with a positioning hole for receiving a positioning bar on tail end of said lock cylinder of said lock device.

12. A lock device mounted in front-fork shaft of a bicycle comprising a fixed member, a lock device, a sliding block, and a round shaft, steel balls and a cylindrical spring, and features thereof being described as follows:
upper part of said fixed member in an inner cylinder of said front fork is furnished with a transverse cylindrical hole for receiving a lock device; a positioning bar at tail end of a lock cylinder of said lock device plugged in a positioning hole in said transverse cylindrical hole; a gear portion on outer surface of an outer casing engaged with a gear rack of a sliding block; lower part of said sliding block furnished with a short shaft which connected with a round shaft in a cylindrical hole of said fixed member; surface of said round shaft furnished with a ring groove; mid-part of said cylindrical hole of said fixed member furnished with symmetrical and through round holes which being in communication with through holes of inner cylinder of said front fork; front end of a cylindrical hole of said fixed member mounted with a cylindrical spring, of which one end pushing against lower end of said round shaft; after a key plugged into said lock device and turning to have a gear portion of said outer casing driven said sliding block to move along a guide groove so as to push said round shaft in a cylindrical hole of said fixed member to displace, and then said steel balls in round holes on both sides of said central cylindrical holes being pushed to a space between positioning hole of said frame and through hole of an inner cylinder of said front fork so as to limit said steel balls in said round holes of said fixed member, said through holes of said inner cylinder of said front fork, and said positioning hole of outer cylinder of said frame; in that case, said frame and said front fork being locked up at an angle of 45 degrees.
